(19) United States
(12) Patent Application Publication
(10) Pub. No.: US 2007/0011886 A1
(43) Pub. Date: Jan. 18, 2007

(54) Wallboard cuttting method and device

(76) Inventor: William Bundy Stone, Tulsa, OK (US)

Correspondence Address: W. B. STONE, 1575 EAST 66th STREET, TULSA, OK, 74136-0724, US

(21) Appl. No.: 11/180,661

(22) Filed: Jul. 14, 2005

(51) Int. Cl. B26D 1/04

(52) U.S. Cl. 30/314; 83/56

(57) ABSTRACT

A method and apparatus for cutting wallboard or like construction material wherein the invention utilizes a novel means of utilizing a plurality of beveled cutting blade inserts driven by a reciprocating drive mechanism within a cutting head driven by a detachable power source for the purpose of providing rotating power attachment. Said invention providing an improved wallboard cutting method with rolled paper edges, thus eliminating rough irregular edges and unnecessary scrap.

### BACKGROUND OF THE INVENTION

The present invention relates to a hand held electromechanical device capable of being carried by a construction worker working with wallboard, plaster board, gypsum board, sheet rock, drywall, or like material herein after referred to as wallboard. Said construction workers can sometimes be referred to as dry-wallers. There is currently more than sixty billion square feet of wallboard produced each year for the construction industry.

The present invention may be worn on a construction belt or otherwise be carried by a dry-waller and may be used to trim and fit wallboard pieces by trimming them in a novel and efficient manner. The present invention may also be used with wallboard material being cut on a table, between two or more saw horses, or while being held in place during construction. The Invention may be mounted on a table, wall, or other support means or used as a carry along tool.

This invention is a novel and unique tool aiding improvement in the construction arts. The invention furthermore offers an improved timely and efficient installation method of wallboard installation not presently available in the home and office construction market. Installation of wallboard is commonly nailed or screwed to the wall studs and ceiling rafters of the interior structures of homes and office buildings and requires lots of cutting and fitting.

Wallboard is well known and is widely used in the construction industry as a means for constructing walls, barriers and other structural formations. The use of wallboard is often desirable over more expensive and time consuming conventional wet plaster methods used in the past. A typical sheet of wallboard comprises a gypsum core, a back cover sheet on one surface of the core and a face or front cover sheet on the other core surface.

Wallboard commonly comes in four foot by eight-foot pieces, or sheets, in various thicknesses, including, but not limited to, ⅜ inch, ½ inch and ⅝ inch. Wallboard sheets are commonly cut to be installed side by side, with little clearance, on the irregularly built and dimensioned walls and ceilings of homes and offices. The sheets are typically cut to fit one after the other, by measuring the first and subsequent pieces used to cover the walls and ceilings.

The wallboard sheets, to be cut, are typically laid in a stack on the floor or, on a cutting table, or held in place on the walls or ceiling, and cut or trimmed to fit. Once they are cut and trimmed to fit they are hoisted into place and nailed or screwed to the studs or rafters of the walls and ceilings. Wallboard is difficult to cut in an exact manner and because of its nature of construction is difficult to cut.

Accordingly, there exists a need for an apparatus and method that reduces the amount of wallboard that is scrapped or wasted during the construction process, and in particular the amount of wallboard that is scrapped or wasted due to poor cutting and required splices that are inherent to the construction process wherein cutting the wallboard is difficult and wallboard is wasted.

Although the irregular fitting pieces can be “taped and floated” together with water based plaster material and a perforated paper tape, and left to dry, more labor and time are required. The wallboard joints then have to be additionally sanded to a smooth surface and painted or wall papered to a finished state.

Typically the required dimensions of the first and subsequent pieces of wallboard are transferred, using a retractable steel tape, carried by most dry wallers and construction personnel, onto the wallboard piece by measuring and marking the wallboard with a pen or pencil. Lining up a long straight edge and marking the line to be cut with a pen or pencil then connects the measurement marks, on the wallboard piece.

A box knife or sharp knife is used along with a straight edge to first cut through the smooth or “finishing” side of the wallboard. Next a round rod or similar device is inserted on the other side of the flat wallboard, below this cut, and the wallboard is broken by pressing down on the wallboard across and adjacent to the cut, snapping, breaking, the interior “plaster” portion of the wallboard.

The cut and broken wallboard is now turned over and the paper backing “rough paper side” of the wallboard, that until now hasn't been previously cut, is cut into at this time. This two-sided cutting and breaking action results in an irregular edge of the wallboard piece. Many times the cut edge must be trimmed, with a wood rasp or metal abrading device to allow the pieces to fit together into a tight and smooth fitting joint.

It should be noted that many times the cutting and breaking action results in an edge whereby the paper covering is rolled outward precluding a smooth paper edge. A straight cut edge with non-rounded or protruding paper edges is preferred in the industry. This is preferred so that the first and subsequent cut pieces may fit together tightly, with minimum gaps, so the pieces may be screwed or nailed, side by side, to the joints, commonly the thin edge of a two by four structural member.

It is apparent that large gaps between the fitted pieces of wallboard result in less available wallboard material to nail or screw the wallboard to the studs and rafters, and requires more labor and plaster material to tape and float the resulting joints. The more inefficient and irregular the wallboard joints are, the more time and money is spent in hand fitting the pieces together and more time is spent to cover up, “tape and float,” this inefficiency.

The above is a description of typical methods of cutting and fitting “almost” straight edged wallboard pieces together. Wallboards must also be fitted around; circular vents, round or arched staircases, chimneys, and wall protrusions that require arcs that must be cut into the wallboard sheets to fit them efficiently into place. It is extremely difficult, if not impossible; to cut and break curved arcs by the methods described above. These types of curved edges required that they are cut with a Saber Saw, or hand saw, that is commonly used which creates a breathing hazard due to the gypsum dust created. This also requires the use of a table or saw horses to provide clearance for the reciprocating blade.

Due to the inaccuracies of current construction methods the walls and ceilings of many homes and office buildings are not “square” and straight line cuts on wallboard pieces don't match up when the wallboard is held in place to be attached. It is common in the industry to fit each wallboard piece in place by cutting and trimming.

There are also embodiments whereby the electromechanical device may be fitted to a cutting table to more efficiently cut the wallboard pieces. This electromechanical device that is fitted in a computer driven cutting table may be used to pre-cut wallboard pieces that are numbered and stored prior to installation. Then the hand held embodiment of the device may be used to efficiently trim and fit the wallboard pieces where required.

The invention surpasses the existing need for improved wallboard cutting needs and will overcome the problems associated with the existing methods and prior art methods used today in the construction industry.

### BRIEF SUMMARY OF THE INVENTION

An object of the present invention is to cut and trim wallboard, used in the home and office construction market that is used to cover the interior walls and ceiling surfaces, in a straight, arced, or circular line in a manner to minimize or eliminate rough and irregular edges thereby allowing two pieces of cut wallboard to be efficiently butted together, over a stud or rafter, and be nailed or screwed to said stud or rafter.

This is accomplished by one or more Scotch Yoke driven knifes, driven at high speed perpendicular to a piece of wallboard, and opposite a Scotch Yoke driven knife in a coincident vertical plane on the other side of the wallboard, both Scotch Yoke driven knifes simultaneously penetrating the paper coverings, and penetrating into the interior plaster material causing it to fail or break, and then retracting from the wallboard in a continuous synchronized motion.

Another object of the invention is for the two or more opposed Scotch Yoke driven knifes, in a singular or wave motion, to penetrate the bonded paper coverings of the wallboard at the same time. The two opposed Scotch Yoke driven knifes, after penetrating the bonded paper coverings to penetrate the gypsum, or center portion, of the wallboard to a preset specific depth at the same time providing for a more efficient cut.

Another object of the invention is for the two opposed Scotch Yoke driven knifes wedged profile to initiate a stress crack between the two or more points of the Scotch Yoke driven knifes that will crack or break the center material of the wallboard between the two knifes. The knifes additionally leave a profile line creating a smooth cutting operation.

An object of the invention is for the two or more Scotch Yoke driven knifes, to be synchronized by the gearing on the drive shaft and gear driven camshaft. Another object of the invention is for the two drive shafts to be held together in non-rotating sliding contact facilitated by a coupling.

An object of the invention is that the drive shafts fit into a coupling that is held in place, between the two drive shafts, when the top housing and bottom housing are screwed together. Another object of the invention is that the drive shafts are in rotational contact with the thrust bearings, and turns inside of the thrust bearings, which are held in place by the top and bottom housings, which bolt together.

The drive shafts, driven by an electric motor and gearing mechanism, described later as the power drive, supplies rotational power to the cutter head. Another object of the invention is that the power drive fits and locks into a top cover that has a locking mechanism in it, that is bolted to the top and bottom housing

Another object of the invention is that the locking ring and lock mechanism in the top cover and power drive locking ring allows the cutter head and power drive to be locked together in a plurality of positions to the top and bottom housing. This is to allow the cutting head and power drive to be locked together in a plurality of circular positions to facilitate the cutting and trimming of the wallboard material.

A still further object of the invention is that the electric motor and gearing mechanism, known as the power drive, will fit, and lock, into the top cover, one of which is attached to the top and bottom housings. This allows more positions, to allow the wallboard-cutting device to fit into an infinite number of tight and confining situations, to attach the cutting head and electric motor and gearing mechanism together.

The foregoing and other objectives, features, and advantages of the invention will be more readily understood upon the consideration of the following detailed description on the invention as well as other objects and advantages of the invention.

### BRIEF DESCRIPTION OF THE DRAWINGS

FIG. 1 is a schematic of the Wallboard Cutting Device shown with a power drive

FIG. 2 is a schematic of the Wallboard Cutting Device shown without a power drive

FIG. 3 is an isometric view of a typical power drive showing a connection means.

FIG. 4 is a cut section isometric view of taken from FIG. 2.

### DESCRIPTION OF THE DRAWING ITEMS

2—Wallboard Cutting Device

4—Power Drive

6—Rotating Mechanism

10—Top Cover

12—Connection gear ring

14—Connection Means

16—Bottom Cover

18—Locking Means

20—Cutting Head Drive Connection

22—Drive Coupling

24—Thrust Bearing

26—Drive Shaft

28—Housing

30—Miter Gears

34—Cam Shaft

36—Blade Inserts

38—Cams

40—Front Cover

42—Rear Cover

### DETAILED DESCRIPTION OF THE INVENTION

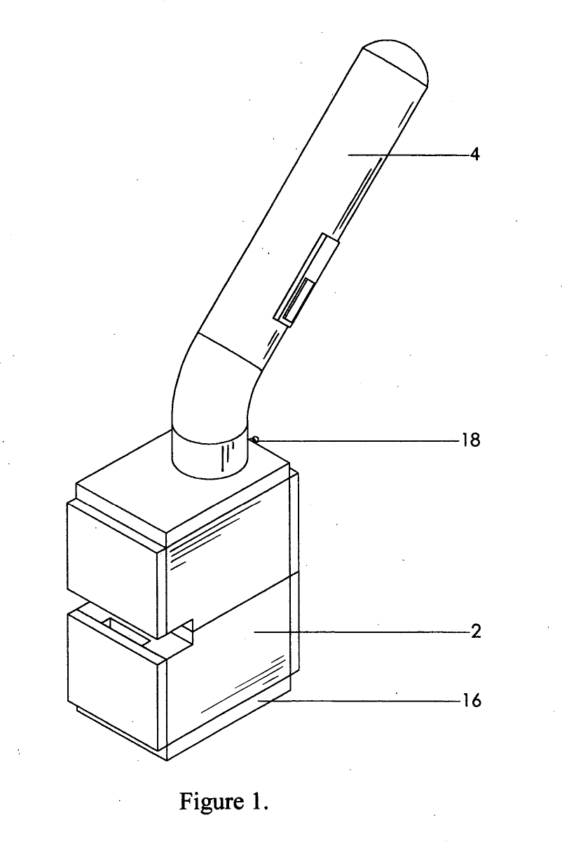

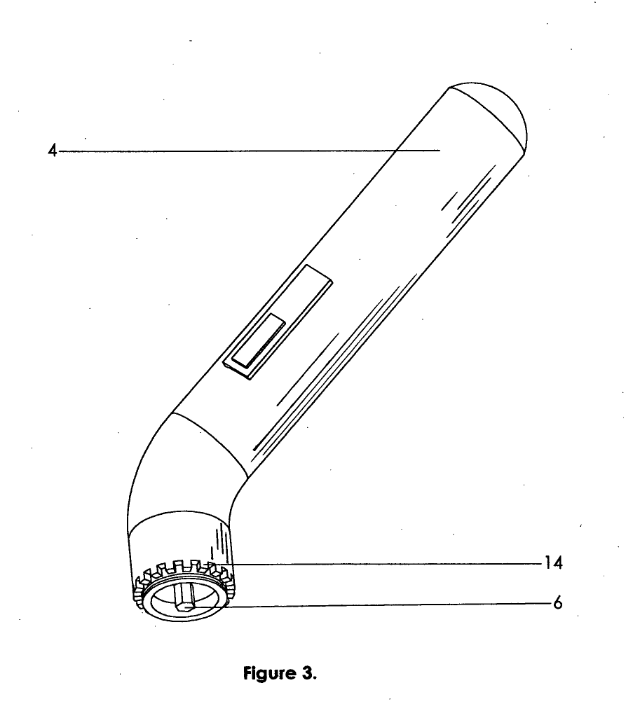

FIG. 1 indicates a Wallboard Cutting Device indicated by number 2 and is generally described as an electromechanical hand held device used in the cutting and trimming of wallboard that is used to cover the interior walls and ceilings of residential homes and commercial buildings. The wallboard cutting device 2 shown in FIG. 1 shows a detachable rotating power drive 4 powered by either a rechargeable battery, electrical connection, or other like power source for the purpose of driving a rotating mechanism 6, shown in FIG. 3, that may include a socket or drive connection (not shown) that may be inserted and removed within a complementary and mating connection and be held in direct communication with a wallboard cutting head device 2 described as follows.

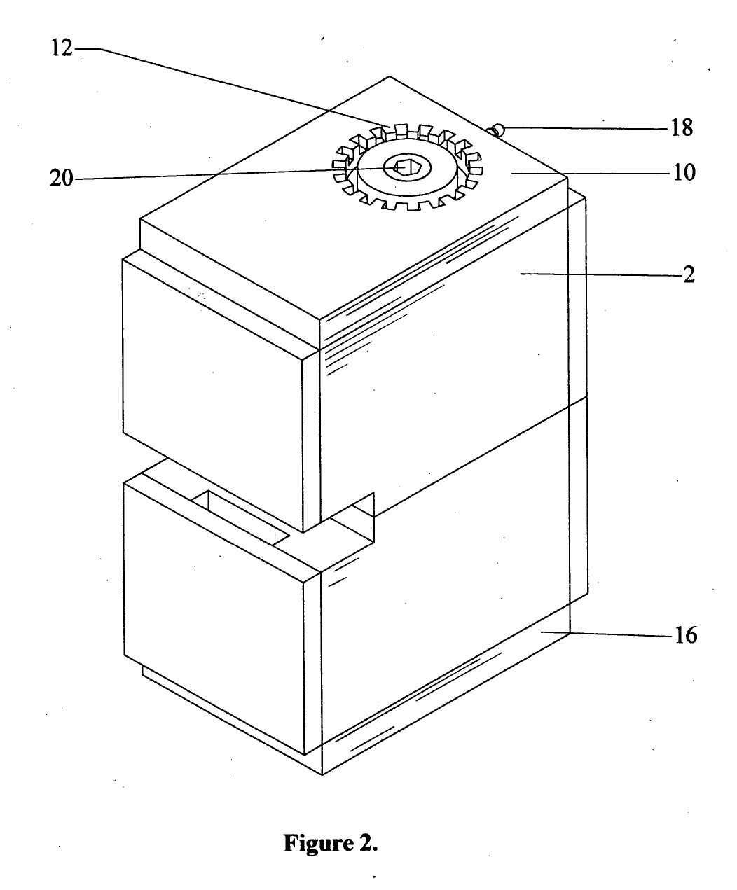

Now referring to FIG. 2, the cutting head device 2 has a top cover 10 that has a circumferential connection gear ring 12 that mates in a plurality of positions about the circumference of a gear ring or other power drive connection means 14 on the power drive 4 as shown in FIG. 3. Said mating gear ring or power drive connection means 14 may include a series of communicating teeth and allow the power drive 4 to be rotationally positioned relative to the cutting head apparatus 2 allowing the operator of the wallboard cutting device to position the cutting head apparatus 2 at different positions relative to the power drive 4. The power drive 4 may be attached to either the top cover 10 or the bottom 16 of the wallboard cutter device 2 as the top cover 10 and bottom cover 16 are both identical.

The power drive 4 may have a locking means 18 that locks the power drive 4 to the cutting head apparatus 2 as shown in FIG. 1. The rotating mechanism 6 shall provide the drive connection to transfer rotating power from the power drive 4 to the cutting head 2 when engaged in direct contact with cutting head drive connection 20 as shown in FIG. 2.

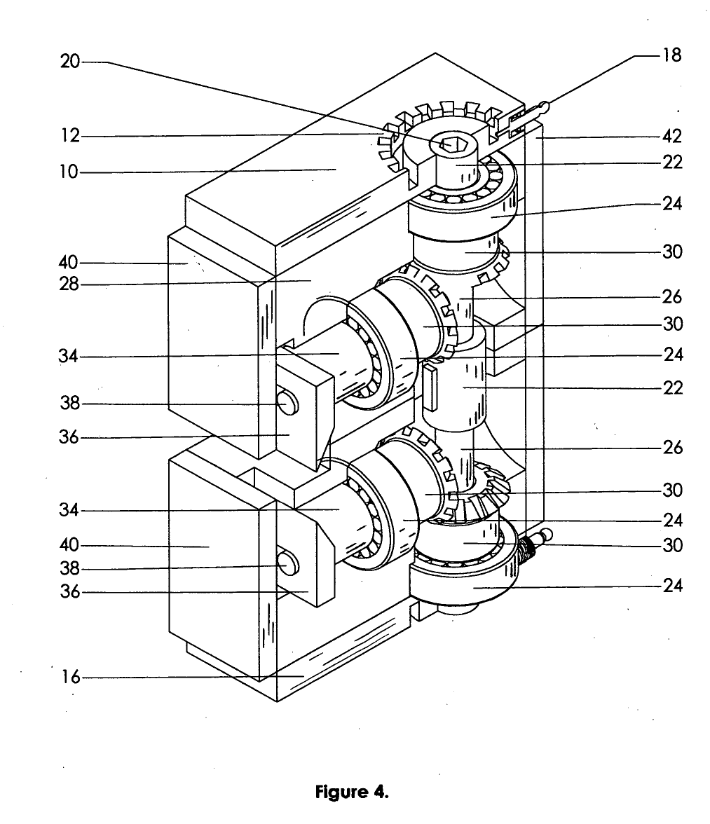

Now referring to FIG. 4, the power drive 4, as shown in FIG. 1, transfers rotating power through a drive coupling 22 placed within a thrust bearing 24 and in direct communication with the drive shaft 26 located in the housing 28. Two miter gears 30 are positioned by thrust bearings 24 affixed to cam shafts 34 and transfer rotating power to the two blade inserts 36.

Referring to FIG. 4, the two cam shafts 34 transfer rotating power through the two cams 38 to the two blade inserts 36. The cam shafts 34, cams 38, and blade inserts 36, which fit inside the housing 28 are functionally a Scotch Yoke mechanism known in the art hereinafter described.

Referring to FIG. 4 the preferred embodiment of the wallboard cutter device 2 shows the two blade inserts 36, positioned to penetrate and cut through the two paper coatings and further penetrating into the gypsum plaster and initiating multiple stress fractures which causes the wallboard to be smoothly and efficiently cut while also rolling over the wallboard surface paper. Different blade inserts 36 can be exchanged for different size wallboard and different construction materials.

It can be seen from FIG. 4, that by dragging an operating wallboard cutter device 2 along the edge of the wallboard to trim it, or across the center portion of a sheet of wallboard in a table mounted embodiment, the sweeping movement of the operating wallboard cutting device will cause the wallboard to be cut and fractured at a predetermined point cutting the sheet smoothly into separate pieces. The wedge surface of the blade inserts 36 causes the trimmed piece of the wallboard to be pushed apart and away from the main body of the now trimmed wallboard.

The invention can operate with rotation in either direction of the two drive shafts 26 about their axis which are coupled together by a drive coupling 22, which rotates both cam shafts 34 simultaneously about their axis through two miter gears 30. The rotating cam shafts 34 rotate the two cams 38 in a circle about the axis of the cam shafts 34. The motion of the cams 38 causes the blade inserts 36 to reciprocate vertically in synchronized motion. The two blade inserts 36 open apart from each other and close towards each other. The housing 28 and the front covers 40 restrain the blade inserts 36. The reciprocating blade inserts 36 are driven in a reciprocating vertical cutting motion. This mechanism is known in the art as a Scotch Yoke.

Now with reference to the above it may be seen that by removing the front cover 40, the blade inserts 36, and cam 38, all three of which are wearable and replaceable items, may be easily replaced in the field. Also, blade inserts 36, having different profiles may be substituted when cutting different materials than wallboard such as wood, plastic, metal, etc.

Now with reference to the above it may be seen that by removing the top cover 10, front cover 40, bottom cover 16, and or rear cover 42 from the housing 28 the wallboard cutting device 2 may be geared for different speeds and or replacement of thrust bearings and all internal working parts. Furthermore, by separating the housing 28 the drive coupling 22 may be replace or used with a shimmed drive coupling (not shown) to space the blade inserts 36 at different distances from different materials to be cut.

It should be noted that the Wallboard Cutting Device 2 may be used to cut plastic, wood, leather, linoleum, etc. by the above-described device. It should also be noted that the invention may be made out of any rigid suitable material.

Other embodiments of this invention use multiple blade inserts.36 mounted side by side, that are driven in a synchronized wave motion, to cut the wallboard at multiple, adjacent and-overlapping places to efficiently and speedily cut any wallboard. This embodiment may be used in the computer driven table-mounted embodiment as described. It should be noted that the present embodiment is preferably used to trim thin edges and used to preferably to cut radiuses in a freehand manner.

What I claim as my invention is:

1. A cutting devise and method for improved cutting of wallboard or like material comprising a cutting head with a detachable rotating power source with a complementary locking and adjustable-connection means wherein a plurality of improved beveled cutting blades driven by a reciprocating drive mechanism provide for an improved cutting operation wherein blades fold in the wallboard covering paper from each side while creating a fracture point so that wallboard can be cut with less dust and waste while also offering a better butt connections between multiple wallboards.

2. A wallboard cutting device as described in claim 1 wherein cutting head is mounted on a cutting table for cutting larger pieces of wallboard.

3. A wallboard cutting device as described in claim 1 wherein cutting head is mounted on a wall platform.

4. A wallboard cutting device as described in claim 1 wherein detachable power means is permanent and not detachable.

5. A wallboard cutting device as described in claim 1 wherein AC power is utilized as a power source.

6. A wallboard cutting device as described in claim 1 wherein each cutting section has a mechanical adjustment means for wallboard width adjustment.

7. A wallboard cutting device as described in claim 1 wherein shims are placed between cutting sections for adjustment of wallboard thickness.

8. A wallboard cutting device as described in claim 1 wherein multiple blade inserts are mounted side by-side.

9. A cutting devise and method for improved cutting of wallboard or like material comprising a cutting head wherein a single improved beveled round cutting blade provide for an improved cutting operation wherein blade forces in the wallboard covering paper while creating a fracture point so that wallboard can be cut from one side

10. A wallboard cutting device as described in claim 9 wherein blade has a serrated edge.

11. A wallboard cutting device as described in claim 9 wherein 2 blades are utilized for trimming wallboard edge.

12. A wallboard cutting device as described in claim 9 wherein 2 blades have serrated edges.

13. A cutting devise and method for improved cutting of wallboard or like material comprising a cutting head wherein dual improved beveled round cutting blade provide for an improved cutting operation wherein blade forces in the wallboard covering paper while creating a fracture point so that wallboard can be trimmed with said blades having an adjustable connection means between rollers for adjustment of fracture depth in wallboard.

14. A wallboard cutting device as described in claim 13 wherein blades have a serrated edge.
